(19) United States
(12) Patent Application Publication
(10) Pub. No.: US 2004/0178731 A1
(43) Pub. Date: Sep. 16, 2004

(54) Outside electrode discharge lamp

(76) Inventors: Yuji Takeda, Ehime (JP); Masami Takagi, Ehime (JP)

Correspondence Address: BANNER & WITCOFF, 1001 G STREET N W, SUITE 1100, WASHINGTON, DC, 20001, US

(21) Appl. No.: 10/482,133

(22) PCT Filed: Jun. 25, 2002
(86) PCT No.: PCT/JP02/06358

(30) Foreign Application Priority Data
Jun. 27, 2001 (JP) 2001-194868

(51) Int. Cl. H01J 11/00

(52) U.S. Cl. 313/607

(57) ABSTRACT

An external electrode discharge lamp 11 is provided with dielectric barrier type electrodes 30 and 40 on an outer surface of end portions of a tubular glass vessel 20. An inner wall of the tubular glass vessel of the lamp 11 is covered with a protective layer 70, 90 made of a metal oxide layer, for example, at least at a portion where the electrodes are arranged, so that the inner wall is not exposed to the inside space of the vessel 20. With the feature, a hole is prevented from being formed at a portion of the tubular glass vessel, and a long life lamp can be provided.

### FIELD OF INVENTION

The present invention relates to a low-pressure discharge lamp having dielectric barrier discharge type electrodes, and especially to an external electrode discharge lamp that is composed of a tubular glass vessel enclosing a discharge medium therein and has electrodes on an outer surface on both ends of the tubular glass vessel.

### BACKGROUND TECHNOLOGY

Conventionally, a low-pressure discharge lamp having dielectric barrier discharge type electrodes is known to the public, which is described in the Japanese Utility Model laid-open publication S61-126559. FIG. 1 is a cross section showing the conventional low-pressure discharge lamp and FIG. 2 is a cross section along the A-A line of FIG. 1. As shown in FIG. 1, In a low pressure discharge lamp 10, an ionizable discharge medium 4, which is mainly composed of a rare gas or a mixture of mercury and rare gas is enclosed in a tubular glass vessel 1 air tightly. Electrodes 2 and 3 are provided on an outer surface of both ends of the tubular glass vessel 1. The electrodes 2 and 3 are mounted by fitting “C” shaped metal conductor 2A, 3A, having a spring elasticity, around the outer circumference of the both ends of the tubular glass vessel 1, as shown in FIG. 2. The discharge lamp having the electrodes 2 and 3 provided around the outer circumference of the both ends of the tubular glass vessel 1, as shown in the figure, is called as an external electrode discharge lamp. Another structure of such external electrode s 2 and 3 is also known, in which a metal foil such as an aluminum tape is wound around the outer surface of the glass vessel and is adhered by, for example, an acrylic adhesive, to make the electrode and the glass vessel contact closely.

In general, the external electrode discharge lamp is regarded as a capacitor in an equivalent circuit shown in FIG. 3. The capacitance C of a capacitor is represented by a following formula.

C=εS/d

Here, ε is a dielectric constant of the glass vessel 1; S is an effective area of the external electrode s 2 and 3; and d is a thickness of the glass vessel 1.

This formula indicates that, when the specification of the glass vessel 1 is constant, the capacitance C is approximately proportional to the area S of the external electrode.

Conventionally, a low-pressure discharge lamp is also known, in which a phosphor layer is formed on an inner surface of the tubular glass lamp vessel 1. This low-pressure discharge lamp is used as a fluorescent lamp. In the conventional low-pressure discharge lamp 10 shown in FIG. 1, when a high frequency voltage is applied between the electrodes 2 and 3, the tubular glass vessel 1 is supplied with an electric power since the glass portion inside the electrodes 2 and 3 acts as a dielectric material. Thus, the discharge medium 4 is ionized and light is emitted. In the low pressure discharge lamp 10 used as a fluorescent lamp, the light emitted from the discharge medium 4 irradiate the phosphor layer formed on the inner surface of the tubular glass lamp vessel 1 thereby emitting fluorescence.

Because such external electrode type low-pressure discharge lamp has a positive current-voltage characteristics, it is possible to light a plurality of lamps connected in parallel by a single lighting device, which makes a design of the lighting device far easier.

Further, because the electrodes 2 and 3 is mounted by a structure, in which the “C” shaped metal conductor 2A and 3A having spring elasticity is fitted the tubular glass lamp vessel 1 by making use of the spring elasticity, it has an advantage that the mounting of the electrodes is easy.

However, the conventional external electrode discharge lamp had the following problems. One of the problems is that a hole, having an about 0.1 mm diameter for example, is generated in the tubular glass vessel 1 during the lighting operation of the external electrode discharge lamp, resulting in inability of the lighting. The hole is formed at a position where electrodes of the lamp vessel 1 are arranged. The hole is also formed in the low pressure discharge lamp used as a fluorescent lamp, similarly at a position of the lamp vessel 1 where the electrodes of the lamp vessel 1 are arranged. Examining the reasons of hole generation at the tubular glass vessel 1, it has became clear that the mercury gas contained in the discharge medium 4 is collectively trapped at the inner wall of the tubular glass vessel 1, and the discharge is concentrated at the spot where the mercury gas is trapped, resulting in local heating and finally melting the glass.

An object of the present invention is thus to solve such conventional problems, and to provide an external electrode discharge lamp, which is able to prevent the forming of the hole in a particular position of a tubular glass vessel, and to provide a longer life.

### DISCLOSURE OF THE INVENTION

The external electrode discharge lamp according to the present invention has a dielectric barrier type electrode on an outer circumference of an end portion of a tubular glass vessel, and a protective layer formed on an inner wall of the tubular glass lamp vessel at least at a portion where the electrode is arranged, so that the portion of the inner wall may not be exposed to an inside space of the lamp vessel.

The protective layer is a metal oxide layer. The protective layer may also be formed by a two layer construction, in which a phosphor layer and a metal oxide layer are laminated, or may be formed by a three or more layer construction, in which a metal oxide layer and a phosphor layer are alternately laminated.

Further, the protective layer may be made of a mixture of phosphor and metal oxide. As a metal oxide used for the protective film, one or more materials may be used selected from the group consisting of titanium oxide, aluminum oxide, yttrium oxide, and zinc oxide.

### BRIEF DESCRIPTION OF THE DRAWINGS

FIG. 1 is a cross section of a conventional external electrode discharge lamp.

FIG. 2 is a cross section along the A-A line of the electrode portion in FIG. 1.

FIG. 3 is an equivalent circuit of a conventional external electrode discharge lamp.

FIG. 4 is a cross section of the low-pressure discharge lamp according to the first embodiment of the present invention.

FIG. 5 is a cross section of the low-pressure discharge lamp according to the second embodiment of the present invention.

FIG. 6 is a cross section of the low-pressure discharge lamp according to the third embodiment of the present invention.

FIG. 7 is a cross section of the low-pressure discharge lamp according to the fourth embodiment of the present invention.

FIG. 8 is a cross section of the low-pressure discharge lamp according to the fifth embodiment of the present invention.

FIG. 9 is a cross section of the low-pressure discharge lamp according to the sixth embodiment of the present invention.

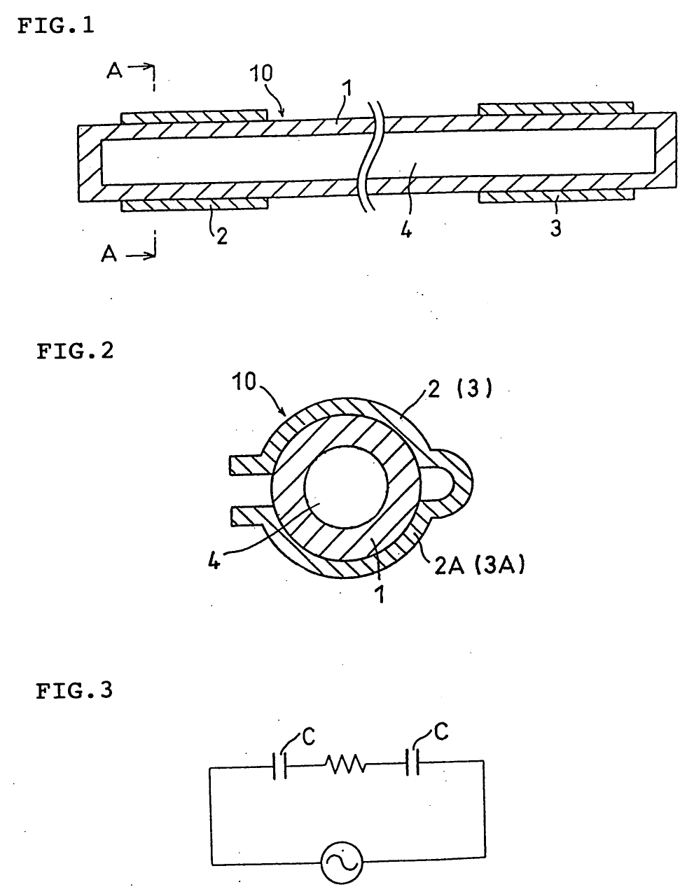

### DETAILED DESCRIPTION OF THE INVENTION

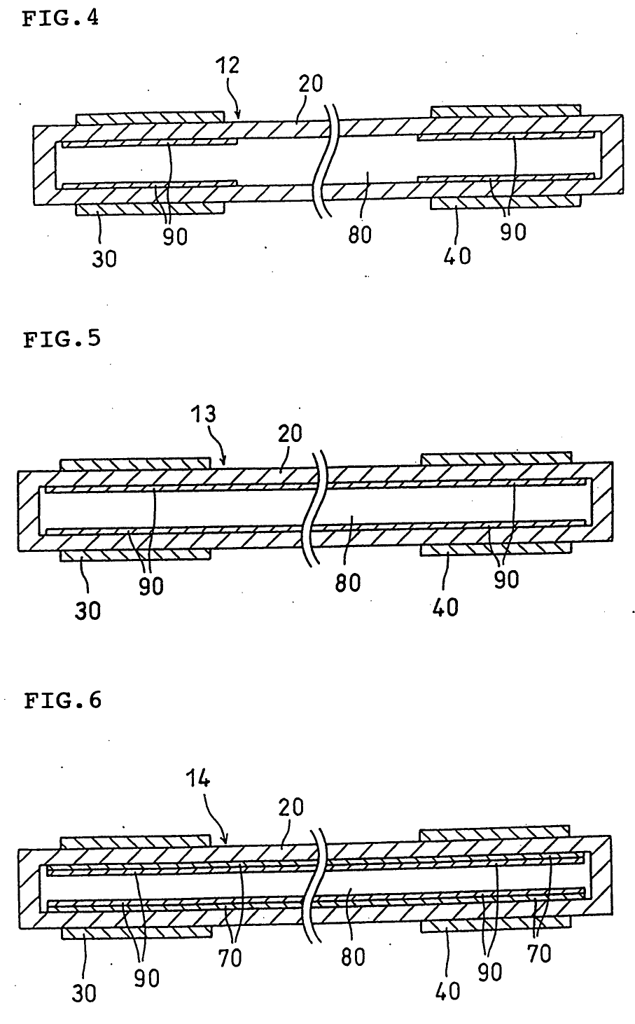

The embodiments of the invention will be explained below in detail referring to the figures appended. FIG. 4 shows the construction of an external electrode discharge lamp having a dielectric type electrode according to the first embodiment of the present invention. In FIG. 4, the external electrode discharge lamp 12 has a tubular glass vessel 20. The tubular glass vessel 20 has sealed both ends and encloses an ionizable discharge medium containing mercury and rare gas. On a circumference of the both ends along the tube axis of the tubular glass vessel, electrodes 30 and 40, which have similar structure to the conventional one described above, are provided respectively.

On the inner surface of the both ends of the tubular glass vessel 20, a metal oxide layer 90 is formed, so that the inner wall of the glass vessel 20 is protected. Specifically, the inner surface of the tubular glass vessel is not made contact with the discharge medium 80 by covering the inner wall of the tubular glass vessel 20 at portions where the electrodes 30 and 40 are provided with the metal oxide layer 90. As the metal oxide, one material or a mixture of a plurality of materials selected from the group consisting of, titanium oxide, aluminum oxide, yttrium oxide, and zinc oxide, can be used.

As mentioned above, the reason why holes are formed on the tubular glass vessel 1, is that the mercury gas contained in the discharge medium 80 is trapped at a portion on the inner wall of the tubular glass vessel 1 and is aggregated there, where the discharge is concentrated, resulting in a local heating and melting of the glass. According to the present invention, the glass material is protected and thus covering the inner surface of the tubular glass vessel 20 at least at the portion where the electrodes 30 and 40 are provided with a protective layer such as a metal oxide layer 90 prevents the forming of the hole in the vessel 20. The protective layer 90 prevents the inner wall of the glass vessel 20 from being exposed to the inside space of the tubular glass vessel.

Here, the specification of the external electrode discharge lamp 12 shown in FIG. 4 is as follows. The tubular glass vessel 20 is made of borosilicate glass, having an outer diameter of 2.6 mm, an inner diameter of 2.0 mm, and a total length of 350 mm. The electrodes 30 and 40 are composed of aluminum tape, with a thickness of 0.1 mm, and a length of 20 mm. Further, the discharge medium 80 is a mixed gas of neon and argon. The composition ratio of neon/argon is 90 mole %/10 mole %. Sealed pressure is 60 Torr. Mercury of 3 mg of is charged.

A continuous lighting of the external electrode discharge lamp 12, which is thus composed, showed that no hole is formed on the glass for 10,000 hours.

In this case, the glass and electrodes etc. can be prevented from being degraded by ultraviolet ray by using titanium oxide having ultraviolet absorption effect as a metal oxide layer 90. Further, when aluminum oxide having a high ultraviolet reflection effect is used, the glass, electrodes etc. are prevented from being degraded by ultraviolet ray. Further, yttrium oxide, which is material hardly absorbing mercury, is used as the metal oxide layer 90, the consumption of mercury is suppressed by decreasing the absorption of mercury by the glass vessel.

FIG. 5 is a cross section showing the second embodiment of the present invention. The external electrode discharge lamp 13 is provided with a metal oxide layer 90, which is a protective layer, on the entire surface of the inner wall of the tubular glass vessel 20 in contrast with the external electrode discharge lamp shown in FIG. 4.

In this embodiment, the inner glass wall at the end portions of the glass lamp vessel 20 where the electrodes 30 and 40 are provided, are also covered so that the hole may be prevented from being formed in the similar manner with the first embodiment. Any materials listed in the first embodiment can be used as the metal oxide material.

FIG. 6 is a cross section showing the third embodiment of the present invention. In the external electrode discharge lamp 14, the entire inner wall of tubular glass vessel 20 is provided with a two layers of a phosphor layer 70 emitting visible lights having three wave lengths; red, blue, and green, and a metal oxide layer 90 shown in the second embodiment. That is, a phosphor layer 70 is formed on the inner wall of the tubular glass vessel 20, and a metal oxide layer 90 is laminated on the surface of the phosphor layer 70. In this case, the metal oxide layer 90 may be formed partly only on the end portion of the lamp vessel 20.

In this case, the phosphor layer can be prevented from being degraded by ultraviolet ray by using titanium oxide having ultraviolet absorption effect as a metal oxide layer 90. Further, when aluminum oxide having a high ultraviolet reflection effect is used, the phosphor layer is prevented from being degraded by ultraviolet ray. Further, yttrium oxide, which is material hardly absorbing mercury, is used as the metal oxide layer 90; the consumption of mercury is suppressed by decreasing the absorption of mercury by the phosphor layer.

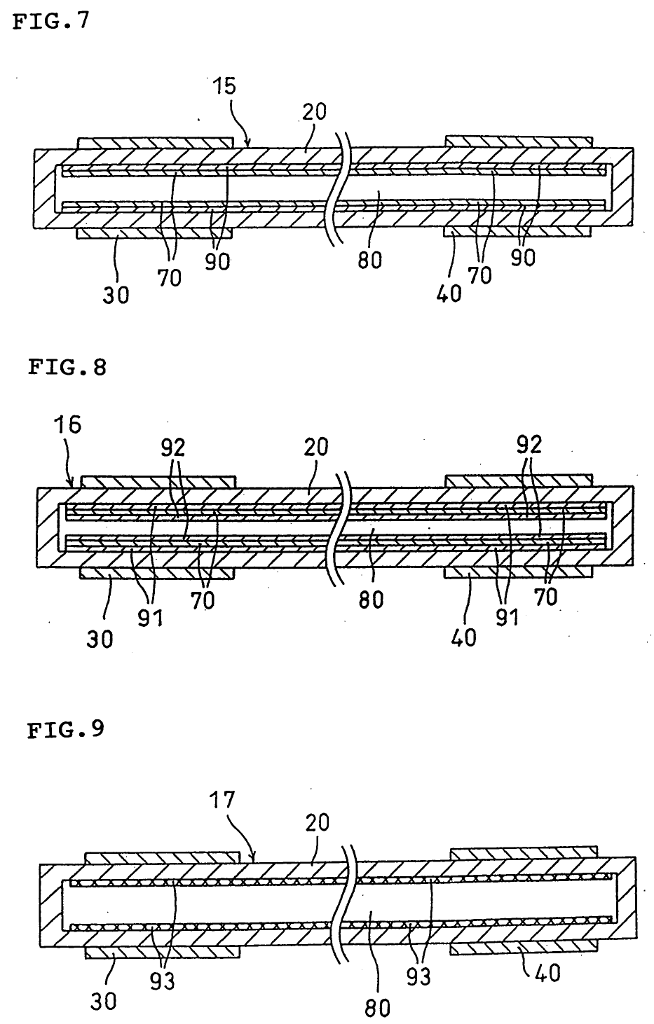

FIG. 7 is a cross section showing the fourth embodiment of the present invention. In the external electrode discharge lamp 15, a metal oxide layer 90 is formed on the inner wall of the tubular glass vessel 20 and a phosphor layer 70 is formed to cover the entire surface of the metal oxide layer 90 in contrast to the external electrode discharge lamp shown in FIG. 15. In this case, the metal oxide layer 90 may be provided only on the end portion of the lamp vessel 20.

FIG. 8 is a cross section showing the fifth embodiment of the present invention. In this external electrode 16, three layers are laminated on the entire inner wall of the tubular glass vessel 20. That is, the layers are a metal oxide layer 91 formed on the entire inner wall of the tubular glass vessel 20, a phosphor layer 70 laminated on the entire surface of the metal oxide layer 91, and another metal oxide layer 92 laminated on the entire surface of the phosphor layer 70. Also in this case, the metal oxide layer 91 and 92 may be provided only on the end portion of the lamp vessel 20 partly.

According to the third to the fifth embodiments, the hole is prevented more effectively from being formed because a protective layers consisting of a metal oxide layer and a phosphor layer is formed on the inner wall of the tubular glass vessel 20 at the portion where electrodes 30 and 40 are arranged, and thus the glass portion is prevented from being exposed to the inside space of the vessel 20.

FIG. 9 shows the sixth embodiment of the present invention. In the external electrode discharge lamp 17, the mixture of the phosphor material and the metal oxide material mentioned above are used as the material of the protective layer. That is, the mixture forms the protective layer 93 at least on the inner wall portion where of the electrodes 30 and 40 are arranged, so that the glass surface is not exposed to the inside space of the glass vessel 20. Consequently, the hole in the glass vessel at the portion where the electrodes 30 and 40 are provided is effectively prevented from being formed.

As described above, in the external electrode discharge lamp according to the present invention, hole generation does not occur during the use of the discharge lamp and the life of the lamp can be made extremely long because a protective layer is formed on the inner wall of the glass vessel at least at a portion where the electrodes are arranged and the glass at the portion is not exposed to the inside space of the glass vessel.

1. An external electrode discharge lamp comprising:
a dielectric barrier type electrode on an outer circumference of an end portion of a tubular glass vessel, and
a protective layer formed on an inner wall of the tubular glass lamp vessel at least at a portion where the electrode is arranged, so that the portion of the inner wall may not be exposed to an inside space of the lamp vessel.

2. An external electrode discharge lamp according to claim 1, wherein the protective film is composed of a metal oxide film.

3. An external electrode discharge lamp according to claimed in claim 2, wherein the metal oxide is composed of a material or a mixture of a plurality of materials selected from the group consisting of, titanium oxide, aluminum oxide, yttrium oxide, and zinc oxide.

4. An external electrode discharge lamp according to claim 3, wherein the metal oxide is provided on the inner wall of the tubular glass lamp vessel along its nearly entire length.

5. An external electrode discharge lamp according to claim 4, wherein the discharge medium is rare gas containing mercury.

6. An external electrode discharge lamp according to claim 5, wherein the electrode has a “C” shape member having spring elasticity, which is fitted elastically around the outer surface of the glass vessel.

7. An external electrode discharge lamp according to claim 6, wherein the electrode is provided on the both ends of the glass vessel.

8. An external electrode discharge lamp according to claim 3, wherein the metal oxide layer is laminated on the phosphor layer, which is formed on the inner wall of the tubular glass lamp vessel.

9. An external electrode discharge lamp according to claim 3, wherein a phosphor layer is formed on the metal oxide layer formed on the inner wall of the tubular glass lamp vessel along its nearly entire axial length of the tube.

10. An external electrode discharge lamp according to claim 9, wherein the second metal oxide layer is laminated on the phosphor layer.

11. An external electrode discharge lamp according to claim 3, wherein the protective layer is formed with a mixture of phosphor and metal oxide.

12. An external electrode discharge lamp according to any one of from claim 8 to claim 11, wherein the electrode has a “C” shape member having spring elasticity, which is fitted elastically around the outer surface of the glass vessel.

13. An external electrode discharge lamp according to claim 11, wherein the electrode is provided on the both ends of the glass vessel.

14. An external electrode discharge lamp according to claim 4, wherein the discharge medium is rare gas containing mercury.
